(19) United States
(12) Patent Application Publication
(10) Pub. No.: US 2011/0052016 A1
(43) Pub. Date: Mar. 3, 2011

(54) INFORMATION PROCESSING APPARATUS, CONTROL METHOD FOR THE SAME, AND PROGRAM

(75) Inventor: Yuichi Nishii, Tokyo (JP)

(73) Assignee: CANON KABUSHIKI KAISHA, Tokyo (JP)

(21) Appl. No.: 12/857,700

(22) Filed: Aug. 17, 2010

(30) Foreign Application Priority Data
Sep. 3, 2009 (JP) 2009-204134

(51) Int. Cl. G06K 9/00

(52) U.S. Cl. 382/128

(57) ABSTRACT

An information processing apparatus comprises a storage unit storing, for each identification information that identifies medical testing, a test information that indicates a state of progress of the medical testing. The apparatus notifies the information system of the state of progress of medical testing indicated by a test information; receives, from the image capturing apparatus, a test reservation information request that requests test reservation information and that includes an identification information; and determines whether the image capturing apparatus that has transmitted the test reservation information request can perform offline image capturing. If a determination is made that the image capturing apparatus that has transmitted the test reservation information request can perform offline image capturing, the information processing apparatus notifies, according to reception of the test reservation information request, the information system that the medical testing identified by the identification information included in the test reservation information request is in progress.

### BACKGROUND OF THE INVENTION

1. Field of the Invention

The present invention relates to an information processing apparatus, a control method for the same, and a program, and in particular, that relates to a technique which locally performs testing workflow management between a radiology information system and an image capturing apparatus.

2. Description of the Related Art

A medical system has been known in which a medical image saving apparatus (PACS) that stores medical images and a radiology information system (RIS) are connected to a network. Here, PACS is the abbreviation for Picture Archiving and Communication System. In such a system, a computer terminal on the network communicates with the medical image saving apparatus and the radiology information system to transmit and receive medical images, test state information, test reservation information, and the like.

Medical apparatuses provided with, for example, communication functionality and computer functionality, such as an ultrasonic diagnostic apparatus and an X ray apparatus, can also be connected to and participate in the network of such a medical system. A medical apparatus (modality) that participates in the network can directly exchange obtained medical images, test state information of the medical apparatus, and test reservation information for the medical apparatus with the medical image saving apparatus and the radiology information system, using the communication functionality and the computer functionality.

Medical apparatuses include mobile medical apparatuses such as a visiting car and a mobile C arm that are provided with a moving unit such as a wagon, are transported to a sickroom in which a subject is accommodated, and operated on in the sickroom. When such mobile medical apparatuses, that is, visiting cars, for example, are used, there are a few cases where a plurality of visiting cars are distributed in advance to subjects to be visited and then perform image capturing, and in many cases it is determined at the scene, which visiting car is to perform which test taking into consideration the conditions of the patients or the state of progress of the tests.

In order to perform determine which apparatus is to be used using the RIS, a network in a hospital needs to be established everywhere, and each sickroom needs to be provided with a network connector. In a hospital where a network of the medical system is not established in the sickrooms, even if mobile medical apparatuses are provided with a function to communicate with a communication destination that is connected to the network, it is not possible to exchange medical images and information such as test state information and test reservation information. For this reason, conventionally, there has been a case where in the operation of the system, all the visiting cars hold the same reservation information list, and which apparatus is to be used is determined by a human operation such as a verbal instruction. Note that Japanese Patent Laid-Open No. 2003-233674 discloses a configuration in which a relay apparatus is provided between a modality and an image viewer.

For each test, which includes a plurality of test items (for example, chest X-ray testing, electrocardiography, height/weight, and the like), the RIS holds and manages a test ID and test information that indicates the state of progress of each test item, in association. For example, the test ID corresponds to subject identification information. The RIS holds “not requested” as values of the test information in an initial state.

If a test reservation information request is received from a test apparatus, the RIS sends test reservation information including a list of test IDs associated with the test item corresponding to this apparatus. Then, the value of test information corresponding to this test item is changed to “in progress”.

The test apparatus holds a test order information list to manage the state of progress of tests identified by the test IDs, based on the list of test IDs included in the received test reservation information. Then, the test apparatus notifies the RIS of the state of a test according to reception of cancellation of the test or the end of the test. For example, if the state of a test that indicates “test ended” or “test cancelled” is notified from the test apparatus according to the progress of the test, the RIS performs management assuming that the test has ended.

However, as described above, if all the mobile medical apparatuses hold the same test order information list, while a mobile medical apparatus is not connected to the network, information indicating that a test is in progress cannot be transmitted to the RIS. For this reason, it is possible for another modality that can be connected online to hold a test order redundantly, and thus there is a risk of conducting the test redundantly. On the contrary, if information indicating that a test is in progress is transmitted to the RIS, other mobile medical apparatuses cannot hold the test order information list, and thus inconvenience occurs in operation of such a system.

### SUMMARY OF THE INVENTION

The present invention has been made in light of the above problems, and aims to provide a technique to enable the appropriate management of testing performed by modalities in a medical system that includes a modality that can perform an offline operation.

According to one aspect of the present invention, an information processing apparatus configured to be provided between an image capturing apparatus that captures a medical image and performs medical testing, and an information system that manages a state of progress of the medical testing performed by the image capturing apparatus, the information processing apparatus includes:

a storage unit adapted to store, for each identification information piece that identifies medical testing, a test information piece that indicates a state of progress of the medical testing;

a notifying unit adapted to notify the information system of the state of progress of medical testing indicated by a test information piece;

a request receiving unit adapted to receive, from the image capturing apparatus, a test reservation information request that requests test reservation information and that includes an identification information piece; and

a determination unit adapted to determine whether the image capturing apparatus that has transmitted the test reservation information request can perform offline image capturing,

wherein if a determination is made that the image capturing apparatus that has transmitted the test reservation information request can perform offline image capturing, the notifying unit notifies, according to reception of the test reservation information request, the information system that the medical testing identified by the identification information piece included in the test reservation information request is in progress.

According to another aspect of the present invention, a control method for an information processing apparatus configured to be provided between an image capturing apparatus that captures a medical image and performs medical testing, and an information system that manages a state of progress of the medical testing performed by the image capturing apparatus, the information processing apparatus comprising a storage unit adapted to store, for each identification information piece that identifies medical testing, a test information piece that indicates a state of progress of the medical testing, the control method includes:

a notifying step of notifying the information system of the state of progress of medical testing indicated by a test information piece;

a request receiving step of receiving, from the image capturing apparatus, a test reservation information request that requests test reservation information and that includes an identification information piece; and

a determination step of determining whether the image capturing apparatus that has transmitted the test reservation information request can perform offline image capturing,

wherein if a determination is made that the image capturing apparatus that has transmitted the test reservation information request can perform offline image capturing, according to reception of the test reservation information request, the information system is notified in the notifying step that the medical testing identified by the identification information piece included in the test reservation information request is in progress.

Further features of the present invention will become apparent from the following description of exemplary embodiments with reference to the attached drawings.

### BRIEF DESCRIPTION OF THE DRAWINGS

FIG. 1 is a diagram that depicts the configuration of a medical system.

FIG. 2 is a block diagram that depicts an example of a functional configuration of a proxy server.

FIG. 3 is a flowchart that depicts an example of an operation procedure performed when a test reservation information request is received.

FIG. 4 is a flowchart that depicts an example of an operation procedure performed when a test state is received.

FIGS. 5A, 5B, 5C, 6A, 6B, 6C, 7A, 7B, and 7C show examples of content in a test state database.

FIG. 8 is a block diagram that depicts an example of the hardware configuration of the proxy server.

### DESCRIPTION OF THE EMBODIMENTS

Below, an embodiment of the present invention is described with reference to the drawings.

System Configuration

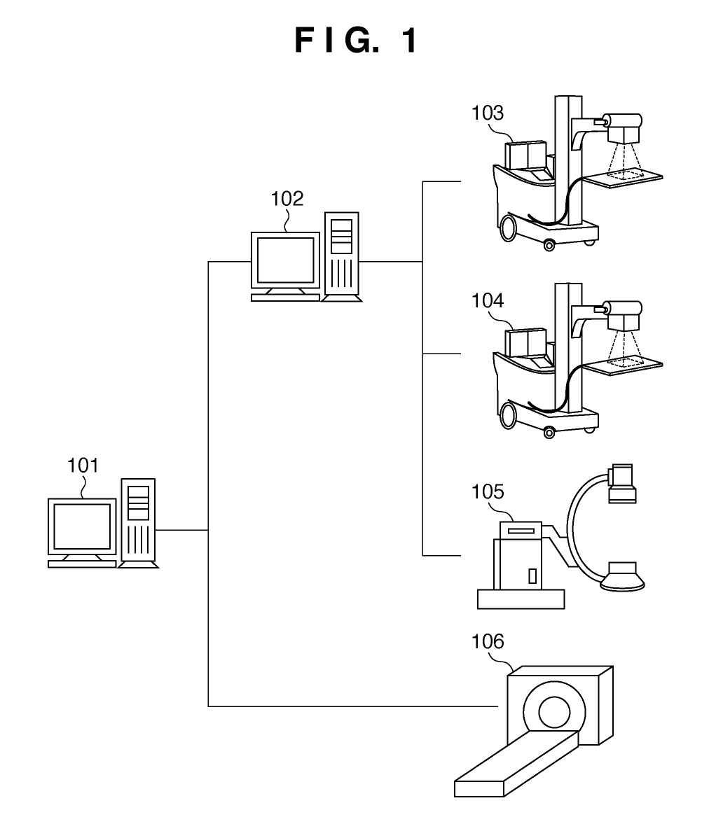

FIG. 1 is a diagram that depicts the configuration of a medical system according to the present embodiment. As shown in FIG. 1, the medical system includes a radiology information system (RIS, information system) 101, a proxy server (information processing apparatus) 102 that performs testing workflow management locally, and image capturing apparatuses 103 to 106.

In the present embodiment, although the image capturing apparatuses 103 to 105 are connected to the RIS 101 via a network through the proxy server 102, the image capturing apparatus 106 is directly connected to the RIS 101 via the network. Accordingly, in the present embodiment, the image capturing apparatuses 103 to 105 are under the control of the proxy server 102, and the image capturing apparatus 106 is outside the control thereof. Although the image capturing apparatuses 103 and 104 are visiting cars, and are image capturing apparatuses that can perform offline image capturing, the image capturing apparatuses 105 and 106 cannot perform offline image capturing. Thus, in the present embodiment, connection between the proxy server 102 and the image capturing apparatuses 103 and 104 may be interrupted. On the other hand, connection is always assured between the image capturing apparatus 105 and the proxy server 102, between the image capturing apparatus 106 and the RIS 101, and between the RIS 101 and the proxy server 102.

The image capturing apparatuses 103 to 106 that capture medical images are also called modalities. The image capturing apparatuses 103 to 106 can be realized by, for example, ultrasonic diagnostic apparatuses, X ray apparatuses, MRI apparatuses, and so on, and have a communication interface for transmitting the captured images to the RIS 101 or the proxy server 102. Note that MRI is the abbreviation for Magnetic Resonance Imaging.

Hardware Configuration of Proxy Server

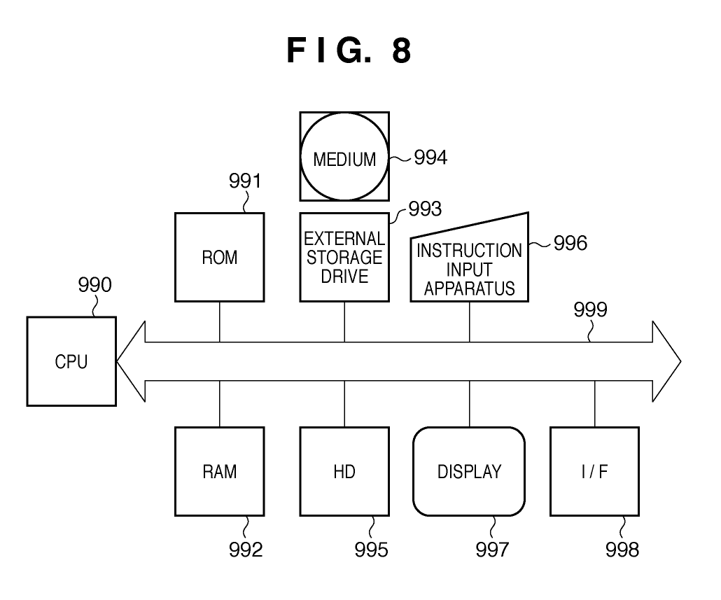

FIG. 8 is a block diagram that depicts an example of the hardware configuration of the proxy server 102 according to the present embodiment. The proxy server 102 is realized by, for example, a personal computer (PC), a workstation (WS), or the like.

In FIG. 8, reference numeral 990 denotes a CPU. The CPU 990 executes application programs, an operating system (OS), control programs, and the like that are stored in a hard disk apparatus 995 described later, and performs control to temporarily store information necessary for executing the programs, files, and the like in a RAM 992.

Reference numeral 991 denotes a ROM, which stores therein programs such as a basic I/O program, and various data used in basic processing. Reference numeral 992 denotes a RAM for temporarily storing various data, which functions as a main memory and a work area of the CPU 990, for instance.

Reference numeral 993 denotes an external storage drive for realizing access to a recording medium, which can load a program and the like that are stored in a medium (recording medium) 994 to this computer system. Note that examples of the medium 994 include a flexible disk (FD), a CD-ROM, a DVD, a USB memory, an MO, and a flash memory.

Reference numeral 995 denotes an external storage apparatus, and a hard disk apparatus (hereinafter, referred to as an HD) that functions as a bulk memory is used therefor in the present embodiment. Application programs, the OS, control programs, related programs, and the like are stored in the HD 995.

Reference numeral 996 denotes an instruction input apparatus, and a keyboard, a pointing device, a touch panel, or the like corresponds thereto. A user issues an instruction by inputting a command or the like for controlling the apparatuses to the proxy server 102 using the instruction input apparatus 996. Reference numeral 997 denotes a display, which displays a command inputted via the instruction input apparatus 996, corresponding response output of the proxy server 102, and the like.

Reference numeral 999 denotes a system bus, which takes charge of a data flow in the proxy server 102. Reference numeral 998 denotes an interface (hereinafter, referred to as an I/F), and data is exchanged with an external apparatus via this I/F 998.

Note that software that realizes functions that are the same as those of the above apparatuses can be substituted for this hardware configuration.

Functional Configuration of Proxy Server

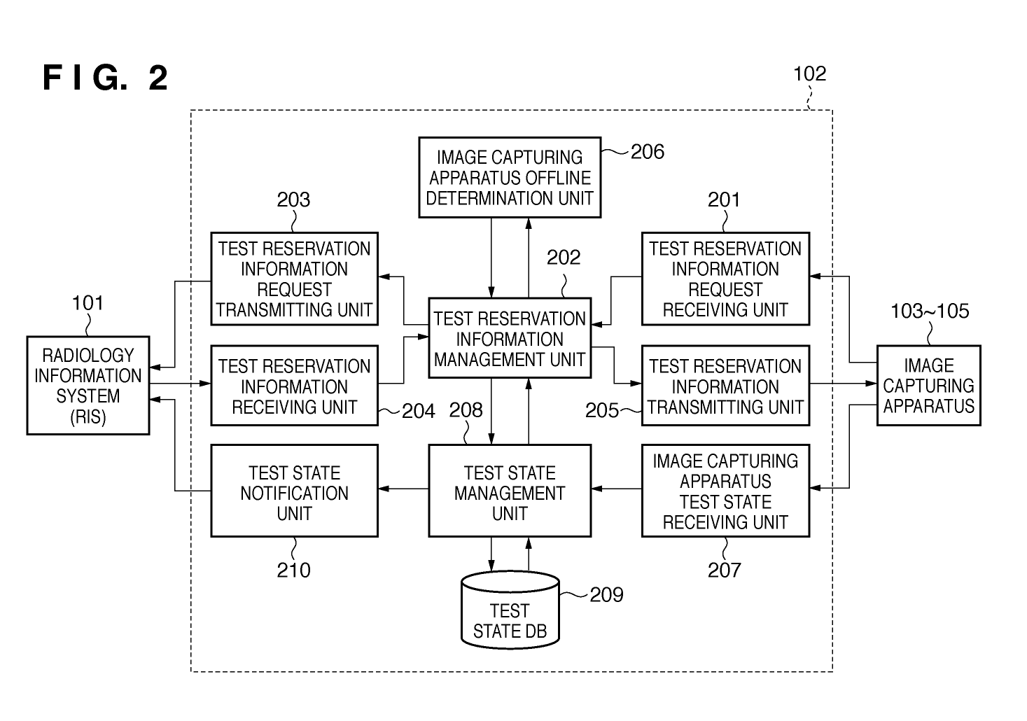

FIG. 2 is a block diagram that depicts the functional configuration of the proxy server 102. As shown in FIG. 2, the proxy server 102 has the following functional elements.

A test reservation information request receiving unit 201 receives a request for test reservation information from the image capturing apparatuses 103 to 105, which are under the control of the proxy server 102.

A test reservation information transmitting unit 205 transmits test reservation information to the image capturing apparatuses 103 to 105, which are under the control of the proxy server 102.

A test reservation information management unit 202 manages test reservation information.

An image capturing apparatus offline determination unit 206 determines whether an image capturing apparatus that has transmitted a test reservation information request can perform offline image capturing.

A test reservation information request transmitting unit 203 transmits a request for test reservation information to the RIS 101.

A test reservation information receiving unit 204 receives test reservation information from the RIS 101.

An image capturing apparatus test state receiving unit 207 receives a test state (progress information that indicates the state of progress of medical testing) from the image capturing apparatuses 103 to 105, which are under the control of the proxy server 102.

A test state management unit 208 and a test state DB 209 manage test states notified from the image capturing apparatus test state receiving unit 207, for each test ID and each image capturing apparatus.

A test state notification unit 210 notifies the RIS 101 of the test state for which the test state management unit has issued an instruction.

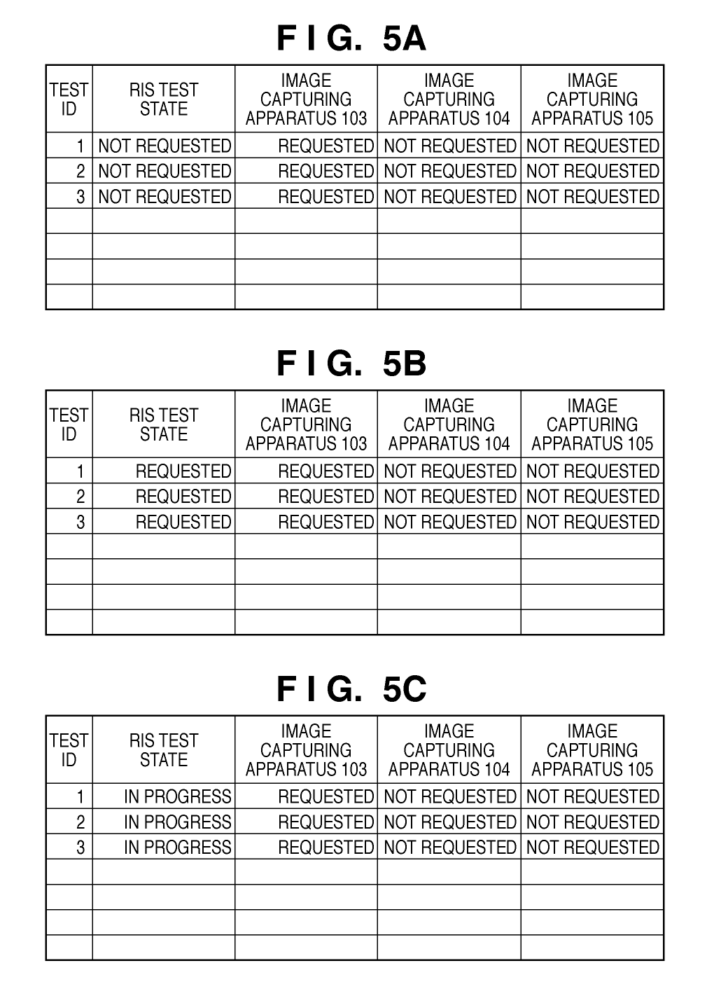

The test state DB 209 is configured as shown in the example in FIG. 5A, and test IDs (identification information of medical testing), RIS test states (test information), and test states of the registered image capturing apparatuses (image capturing apparatus information) are managed therein. In the example of the present embodiment, the RIS test states are managed using status, namely, “not requested”, “requested” and “in progress”, and the image capturing apparatus test states are managed using status, namely, “not requested”, “requested”, “in progress”, and “test ended”.

The image capturing apparatus offline determination unit 206 sets information indicating whether offline image capturing is possible for each image capturing apparatus at the time of installation, for example, and can determine whether an image capturing apparatus can perform offline image capturing using this information. Furthermore, the image capturing apparatus offline determination unit 206 can also determine whether offline image capturing is possible by dynamically receiving, from an image capturing apparatus, a flag indicating whether the image capturing apparatus can operate offline, according to reception of a test reservation information request or an image capturing apparatus test state.

Operation Performed when Test Reservation Information Request is Received

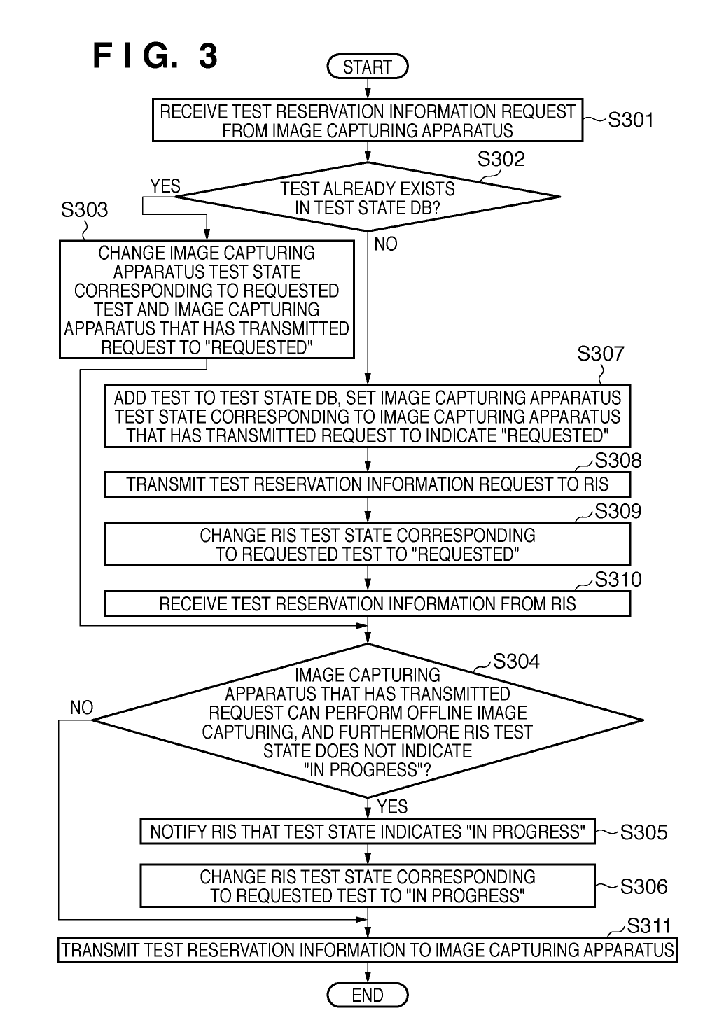

FIG. 3 is a flowchart that depicts an example of an operation procedure performed by the proxy server 102 when a test reservation information request is received from an image capturing apparatus. The operations described below can be executed by the CPU 990 performing overall control of the apparatus, based on the programs stored in a computer-readable storage medium such as the ROM 991.

In S301, the test reservation information request receiving unit 201 of the proxy server 102 receives a test reservation information request from any of the image capturing apparatuses 103 to 105, which are under the control of the proxy server.

Upon receipt of the test reservation information request in S301, the test reservation information management unit 202 of the proxy server 102 checks whether the requested test already exists in the test state DB 209 by transmitting an inquiry to the test state management unit 208 (S302). If it already exists (YES in S302), the processing proceeds to S303, and if it does not exist (NO in S302), the processing proceeds to S307.

In S303, the image capturing apparatus test state corresponding to the requested test and the image capturing apparatus that has transmitted the request in the test state DB 209 is changed to “requested”. Then, the processing proceeds to S304.

On the other hand, in S307, the test is added to the test state DB 209, setting (update) is performed such that the RIS test state indicates “not requested”, the image capturing apparatus test state corresponding to the image capturing apparatus that has transmitted the request indicates “requested”, and the image capturing apparatus test states other than that indicate “not requested”. For example, if a test reservation information request with regard to three tests is received from the image capturing apparatus 103, the content in the test state DB 209 after processing in S307 becomes as shown in FIG. 5A.

Next, in S308, the test reservation information request transmitting unit 203 of the proxy server 102 transmits a test reservation information request to the RIS 101. Then, the RIS test state in the test state DB 209 corresponding to the requested test is changed to “requested” (S309). For example, when a test reservation information request with regard to the tests having test IDs 1 to 3 is transmitted if the content in the test state DB 209 is as shown in FIG. 5A, the content in the test state DB 209 becomes as shown in FIG. 5B. Furthermore, the test reservation information receiving unit 204 of the proxy server 102 receives test reservation information from the RIS 101 in S310, and the processing proceeds to S304.

In S304, the image capturing apparatus offline determination unit 206 of the proxy server 102 determines whether or not both the following conditions (1) and (2) are satisfied.

(1) The image capturing apparatus that has transmitted the request can perform offline image capturing.

(2) The RIS test state in the test state DB 209 does not indicate “in progress”.

If both (1) and (2) are satisfied (YES in S304), the processing proceeds to S305, and if even one of (1) and (2) is not satisfied (NO in S304), the processing proceeds to S311.

In S305, the test state notification unit 210 of the proxy server 102 notifies the RIS 101 that the test state indicates “in progress”. Then, in S306, the RIS test state in the test state DB 209 corresponding to the requested test is changed (updated) to “in progress”, and the processing proceeds to S311.

In S311, the test reservation information transmitting unit 205 of the proxy server 102 transmits test reservation information to the image capturing apparatus that has transmitted the request (S311). Then, the processing ends.

Operation Performed when Test State is Received

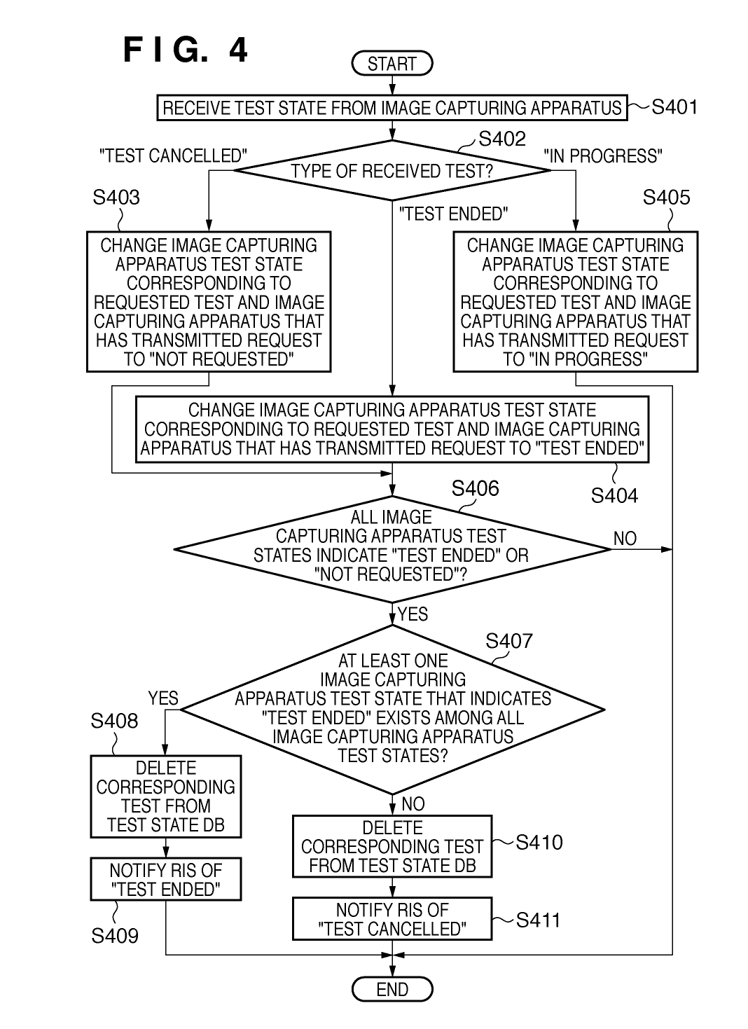

FIG. 4 is a flowchart that depicts the flow of operation of the proxy server 102 when a test state is received from an image capturing apparatus. The operations described below can be executed by the CPU 990 performing overall control of the apparatus, based on the programs stored in a computer-readable storage medium such as the ROM 991.

In S401, the image capturing apparatus test state receiving unit 207 of the proxy server 102 receives a test state from any of the image capturing apparatuses 103 to 105, which are under the control of the proxy server. Next, the type of received test state is determined in S402. If the type of received test state is “test cancelled”, the processing proceeds to S403, and if it is “test ended”, the processing proceeds to S404, and further if it is “in progress”, the processing proceeds to S405.

In S403, the image capturing apparatus test state in the test state DB 209 corresponding to the requested test and the image capturing apparatus that has transmitted the request is changed to “not requested”, and the processing proceeds to S406. In S404, the image capturing apparatus test state in the test state DB 209 corresponding to the requested test and the image capturing apparatus that has transmitted the request is changed to “test ended”, and the processing proceeds to S406. In S405, the image capturing apparatus test state in the test state DB 209 corresponding to the requested test and the image capturing apparatus that has transmitted the request is changed to “in progress”, and the processing ends.

In S406, it is determined whether or not all the image capturing apparatus test states corresponding to the test in the test state DB 209 indicate “test ended” or “not requested”. If all the image capturing apparatus test states indicate “test ended” or “not requested” (YES in S406), the processing proceeds to S407, and if a state other than “test ended” and “not requested” (that is, “requested”) exists (NO in S406), the processing ends.

In S407, it is further determined whether or not even one image capturing apparatus test state that indicates “test ended” exists from among all the image capturing apparatus test states in the test state DB 209. If it exists (YES in S407), the processing proceeds to S408, and if it does not exist (NO in S407), the processing proceeds to S410.

In S408, the corresponding test is deleted from the test state DB 209. Next, in S409, the test state notification unit 210 of the proxy server 102 notifies the RIS 101 of “test ended” (S409). Then, the processing ends.

On the other hand, in S410, which corresponds to the case where all the image capturing apparatus test states in the test state DB 209 indicate “not requested”, the corresponding test is deleted from the test state DB 209. Next, in S411, the test state notification unit 210 of the proxy server 102 notifies the RIS 101 of “test cancelled”. Then, the processing ends.

Example of Operation Performed when Test Reservation Information Request is Received

Next, a description is given with a specific example of the test state DB. First, if the image capturing apparatus 103 transmits a test reservation information request with regard to the test IDs 1 to 3, the proxy server 102 proceeds with processing in the order of S301, S302, S307 to S310, S304 to S306, and S311 in FIG. 3.

Since data does not exist yet in the test state DB 209 in an initial state, the result of S302 is NO, and thus the processing proceeds to S307. In S307, the tests are added to the test state DB 209 (initial test states indicate “not requested”, and initial image capturing apparatus test states indicate “not requested”), and the image capturing apparatus test states corresponding to the image capturing apparatus that has transmitted the request are changed to “requested”. At this time, the test state DB 209 is in a state as shown in FIG. 5A. If a request for test reservation information is transmitted to the RIS 101 (S308), and the RIS test state corresponding to the requested tests are changed “requested”, the test state DB 209 will be in the state as shown in FIG. 5B.

Subsequently, test reservation information is received from the RIS 101 (S310), and determination in S304 is performed. It is determined that the image capturing apparatus (test apparatus) 103 that has transmitted the request is an apparatus that can operate offline, and furthermore the test state of the RIS 101 indicates “requested”. Accordingly, the RIS 101 is notified that the test state indicates “in progress” (S305), and the RIS test state corresponding to the requested test is changed to “in progress” (S306). At this time, the test state DB 209 is in a state as shown in FIG. 5C.

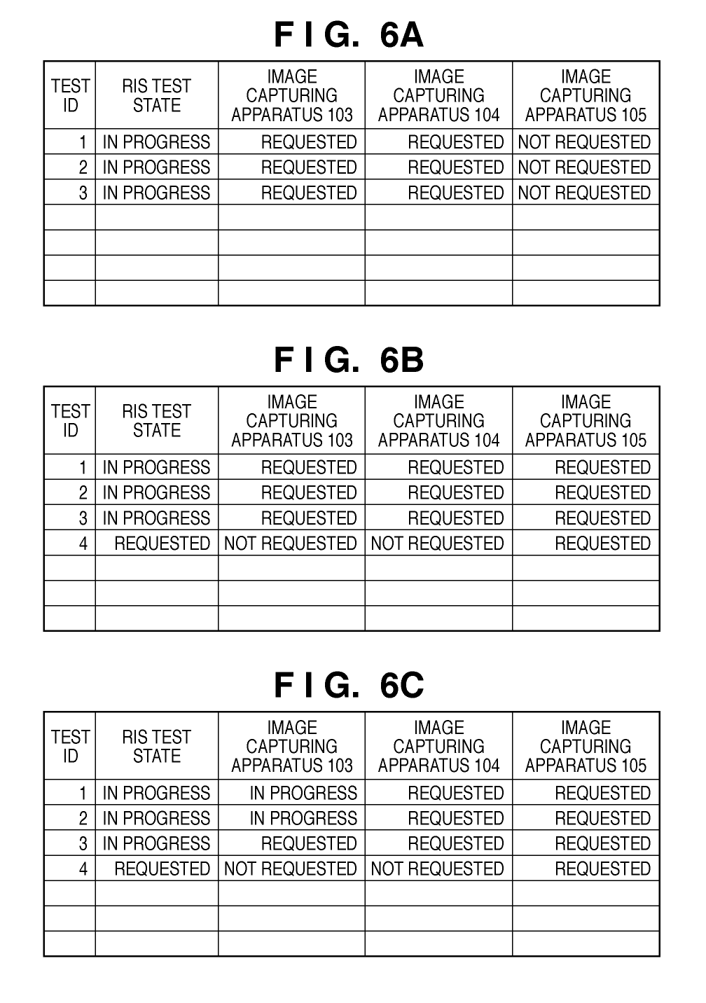

Next, if the image capturing apparatus 104 transmits a test reservation information request with regard to the test IDs 1 to 3, the proxy server 102 proceeds with processing in the order of S301 to S304, and S311 in FIG. 3. Since the tests already exist in the test state DB 209, the result of S302 is YES, and the processing proceeds to S303. In S303, the image capturing apparatus test states corresponding to the image capturing apparatus 104 that has transmitted the request are changed to “requested”. At this time, the test state DB 209 is in a state as shown in FIG. 6A.

Next, determination in S304 is performed, where although it is determined that the image capturing apparatus (test apparatus) 104 that has made the request is an apparatus that can operate offline, the RIS test states indicate “in progress”. Accordingly, the result of S304 is NO, and thus the test state DB 209 is not changed, and test reservation information is transmitted to the image capturing apparatus 104 in S311. At this time, even if the image capturing apparatus 106 transmits a test reservation information request with regard to the test IDs 1 to 3, since the test states are managed as “in progress” in the RIS 101, a test reservation for the image capturing apparatus 106 will not be made. This avoids the image capturing apparatus 106 redundantly performing the test.

Next, if the image capturing apparatus 105 transmits a test reservation information request with regard to the test IDs 1 to 3 and a test ID 4, the proxy server 102 proceeds with processing in the order of S301 to S304, and S311 in FIG. 3 with regard to the test IDs 1 to 3. On the other hand, since the test ID 4 is new and furthermore the image capturing apparatus 105 is an apparatus that cannot be used offline, the processing proceeds in the order of S301, S302, S307 to S310, S304, and S311 in FIG. 3. Thus, since processing in S305 and S306 for changing the RIS test states to “in progress” is not performed, the test state DB 209 will be in a state as shown in FIG. 6B.

Example of Operation Performed when Test State is Received

In the case where the image capturing apparatus 103 has completed the tests having the test IDs 1 and 2, and is connected online, the image capturing apparatus test state “in progress” is notified from the image capturing apparatus 103. In this case, the proxy server 102 proceeds with processing in the order of S401, S402, and S405 in FIG. 4. As a result of the processing, in the test state DB 209, the image capturing apparatus test states of the image capturing apparatus 103 associated with the test IDs 1 and 2 are changed to “in progress” as shown in FIG. 6C.

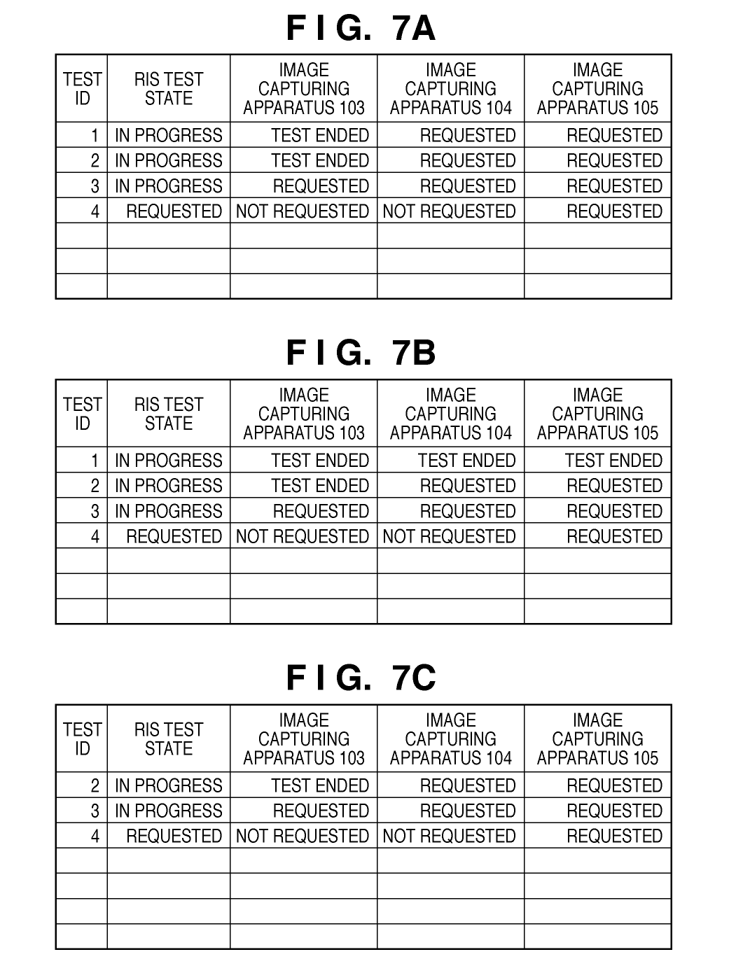

Furthermore, if the image capturing apparatus test state “test ended” is notified from the image capturing apparatus 103, the proxy server 102 proceeds with processing in the order of S401, S402, S404, and S406 in FIG. 4. As a result of the processing, in the test state DB 209, the image capturing apparatus test states of the image capturing apparatus 103 associated with the test IDs 1 and 2 are changed to “test ended” as shown in FIG. 7A.

Similarly, if “test ended” with regard to the test ID 1 is notified from the image capturing apparatus 104, the proxy server 102 proceeds with processing in the order of S401, S402, S404, and S406 in FIG. 4.

Subsequently, suppose that “test ended” with regard to the test ID 1 is also notified from the image capturing apparatus 105. In this case, the proxy server 102 proceeds with processing in the order of S401, S402, S404, and S406 to S409 in FIG. 4. In this case, all the image capturing apparatus test states with regard to that test ID in the test state DB 209 indicate “test ended” after processing in S404 (FIG. 7B). Furthermore, since that test is deleted from the test state DB by performing processing in S408, the test state DB 209 will be in the state shown in FIG. 7C after the processing in FIG. 4.

Similarly, if all the image capturing apparatus test states with regard to a test ID indicate “not requested” (NO in S407), that test is deleted from the test state DB (S410), and the RIS is notified of “test cancelled” (S411).

As described above, according to the configuration of the present embodiment, the operation performed by the proxy server 102 is changed depending on whether or not an image capturing apparatus can operate offline. Specifically, if it is determined that the image capturing apparatus that has transmitted a test reservation information request can perform offline image capturing, the proxy server 102 notifies the RIS 101 that the medical testing is in progress, according to the reception of the test reservation information request. Thus, the plurality of image capturing apparatuses 103 to 105, which are under the control of the proxy server 102, can hold the same test reservation information list, and furthermore it becomes possible to prevent the image capturing apparatus 106, which is outside the control of the proxy server 102, redundantly performing testing.

### Other Embodiments

The present invention is also realized by executing the following processing. That is, it is processing in which software (a program) that realizes the functions of the embodiment described above is supplied to a system or an apparatus via a network or various storage media, and a computer (or a CPU, an MPU, or the like) of the system or the apparatus reads and executes the program code. In this case, the program and the storage medium that stores the program constitute the present invention.

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (for example, computer-readable medium).

As described above, according to the present invention, it is possible to provide, in a medical system that includes modalities that can perform offline operation, a technique for enabling appropriate control of testing performed by the modalities.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-204134, filed on Sep. 3, 2009, which is hereby incorporated by reference herein in its entirety.

What is claimed is:

1. An information processing apparatus configured to be provided between an image capturing apparatus that captures a medical image and performs medical testing, and an information system that manages a state of progress of the medical testing performed by the image capturing apparatus, the information processing apparatus comprising:
a storage unit adapted to store, for each identification information piece that identifies medical testing, a test information piece that indicates a state of progress of the medical testing;
a notifying unit adapted to notify the information system of the state of progress of medical testing indicated by a test information piece;
a request receiving unit adapted to receive, from the image capturing apparatus, a test reservation information request that requests test reservation information and that includes an identification information piece; and
a determination unit adapted to determine whether the image capturing apparatus that has transmitted the test reservation information request can perform offline image capturing,
wherein if a determination is made that the image capturing apparatus that has transmitted the test reservation information request can perform offline image capturing, the notifying unit notifies, according to reception of the test reservation information request, the information system that the medical testing identified by the identification information piece included in the test reservation information request is in progress.

2. The information processing apparatus according to claim 1, further comprising an update unit adapted to update the test information piece corresponding to the identification information piece of the medical testing so as to indicate that the medical testing is in progress, in accordance with notification of the medical testing being in progress.

3. The information processing apparatus according to claim 2,
wherein the storage unit further stores, for each identification information piece and each image capturing apparatus, an image capturing apparatus information piece that indicates the state of progress of the medical testing performed by the image capturing apparatus,
the information processing apparatus further comprises a state receiving unit adapted to receive, from each image capturing apparatus, a progress information piece that indicates the state of progress of the medical testing performed by the image capturing apparatus and that includes the identification information piece,
the update unit updates, according to content of a received progress information piece, the image capturing apparatus information piece corresponding to the identification information piece included in the received progress information piece, and to the image capturing apparatus that has transmitted the progress information piece, and
the notifying unit notifies the information system of the state of progress of the medical testing, based on content of the image capturing apparatus information piece that has been updated.

4. The information processing apparatus according to claim 3,
wherein the notifying unit notifies the information system that, with regard to a test for which all the corresponding image capturing apparatus information pieces indicate that the test has ended, the test has ended.

5. The information processing apparatus according to claim 4,
wherein the update unit deletes, from the storage unit, information on the test for which all the corresponding image capturing apparatus information pieces indicate that the test has ended.

6. The information processing apparatus according to claim 3,
wherein the notifying unit notifies the information system that, with regard to a test for which all the corresponding image capturing apparatus information pieces indicate that the test has been cancelled, the test has been cancelled.

7. The information processing apparatus according to claim 6,
wherein the update unit deletes, from the storage unit, information on the test for which all the corresponding image capturing apparatus information pieces indicate that the test has been cancelled.

8. A control method for an information processing apparatus configured to be provided between an image capturing apparatus that captures a medical image and performs medical testing, and an information system that manages a state of progress of the medical testing performed by the image capturing apparatus, the information processing apparatus comprising a storage unit adapted to store, for each identification information piece that identifies medical testing, a test information piece that indicates a state of progress of the medical testing, the control method comprising:
a notifying step of notifying the information system of the state of progress of medical testing indicated by a test information piece;
a request receiving step of receiving, from the image capturing apparatus, a test reservation information request that requests test reservation information and that includes an identification information piece; and
a determination step of determining whether the image capturing apparatus that has transmitted the test reservation information request can perform offline image capturing,
wherein if a determination is made that the image capturing apparatus that has transmitted the test reservation information request can perform offline image capturing, according to reception of the test reservation information request, the information system is notified in the notifying step that the medical testing identified by the identification information piece included in the test reservation information request is in progress.

9. A program stored in a computer-readable medium for causing a computer to function as the units that the information processing apparatus according to claim 1 comprises.
